(19) United States
(12) Patent Application Publication
(10) Pub. No.: US 2015/0004949 A1
(43) Pub. Date: Jan. 1, 2015

(54) MESSAGE PROCESSING SYSTEM

(71) Applicant: CALLPLEASE, LLC, Valley Village, CA (US)

(72) Inventors: Gregg D. Fienberg, Valley Village, CA (US); Rhys Ryan, Burbank, CA (US); Carl Ludewig, San Rafael, CA (US)

(73) Assignee: CALLPLEASE LLC, Valley Village, CA (US)

(21) Appl. No.: 14/312,408

(22) Filed: Jun. 23, 2014

Related U.S. Application Data
(60) Provisional application No. 61/840,741, filed on Jun. 28, 2013.

(51) Int. Cl. H04M 3/42

(52) U.S. Cl. CPC H04M 3/42136
USPC 455/414.1

(57) ABSTRACT

A system and method for synchronizing data across multiple mobile platforms. Certain embodiments employ a server operating to receive from a first remote device, call action information, test that call action for prior reception of the same information, store the information in a structured data store in response to said testing, transmit a push notification to a second remote device, wait for a response from the second remote device, and transmit the call action to the second remote device based on the response. The remote devices may be cell phones, laptops, tablets and the like and the call actions may include work processes like docketing, sales functions and technical support information.

### PRIORITY

This application claims the benefit of co-pending provisional patent application 61/840,741 entitled “Message Processing System” field Jun. 28, 2013 by the same inventors which, along with its associated appendix, is incorporated by reference as if fully set forth herein.

### BACKGROUND

With technology constantly taking over everyday tasks, many struggle to keep all the tasks organized and prioritized. It is critical to be able to rapidly find and consolidate information in order to take proper action. This demand is most pressing on professionals and sales people who, owing to changes in the workplace, often are remote from their offices or unavailable for long periods of time. Often these professionals will have staff or coworkers who, at times, intervene on the professional's behalf to help manage certain office functions such as answering calls or responding to sales prospects. Accordingly, there is a demand for new tools to help facilitate this function.

### SUMMARY

Disclosed herein is a system and method for synchronizing data across multiple mobile platforms. Certain embodiments employ a server having an API operable to receive from a first remote device, call action information, test that call action for prior reception of the same information, store the information in a structured data store in response to said testing, then transmit a push notification to a second remote device, wait for a response from the second remote device, and transmit the call action to the second remote device based on the response. The remote devices may be cell phones, laptops, tablets and the like and the call actions may include work processes like docketing, sales functions and technical support information.

### BRIEF DESCRIPTION OF THE DRAWINGS

FIG. 1 shows a functional block diagram of a client server system that may be employed for some embodiments according to the current disclosure.

FIG. 2 illustrates an embodiment of a message processing system according to certain aspects of the current disclosure.

FIG. 3 is a flowchart illustrating certain aspects of the current disclosure.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The term “Application Programming Interface” or “API” generally refers to a code-based specification intended to be used as an interface by software components to communicate with each other. An API may include specifications for routines, data structures, data sourcing, object classes, and variables.

The term “Asymmetric Routing” generally refers to a phenomenon that may occur when the forward path is different from the reverse path of a communication. This may entail different routers only seeing a portion of traffic depending on the direction of travel where the routers where used.

The terms “Cloud, “Cloud computing” and “a Computing Cloud” generally refer to colloquial expressions used to describe a variety of different computing concepts that involve a relatively large number of computers that are connected through a real-time communication network (typically the Internet). Cloud computing may be a synonym for distributed computing over a network and means the ability to run a program on many connected computers at the same time.

The term “declarative language” generally refers to a programming language that allows programming by defining the boundary conditions and constraints and letting the computer determine a solution that meets these requirements. Many languages applying this style attempt to minimize or eliminate side effects by describing what the program should accomplish, rather than describing how to go about accomplishing it. This is in contrast with imperative programming, which requires an explicitly provided algorithm.

The word “Middleware” generally means computer software that connects software components or applications. The software consists of a set of enabling services that allow multiple processes running on one or more machines to interact across a network. Middleware conventionally provides for interoperability in support of complex, distributed applications. It often includes web servers, application servers, and similar tools that support application development and delivery such as XML, SOAP, and service-oriented architecture.

The terms “mobile phone” and “cell phone” and the like, generally refer to phones that can make and receive telephone calls over a radio link while moving around a wide geographic area. Conventionally they operate by connecting to a cellular network provided by a mobile phone operator, allowing access to the public telephone network.

The term “push notification” and the like generally refers to technologies to supply data to remote data consumers without requiring the remote data consumer to poll for data changes or periodically update data. In certain embodiments push technology may be effectuated through a continuously open IP connection which allows for forward notifications from devices such as servers and/or third party applications to the remote devices; such notifications may include data, images, text, badges, sounds, custom text alerts and the like.

The terms “smartphone” or “smart phone” generally refer to mobile (or cellular) phones built to include a mobile operating system, thus providing more advanced computing capability and connectivity than a conventional feature phone. For purposes of this disclosure smart phones have an independently programmable operating system capable of accessing a network independently of a phone's conventional without common carrier connectivity.

The terms “virtual machine” or “VM” generally refer to a self-contained operating environment that behaves as if it is a separate computer even though it is part of a separate computer or may be virtualized using resources form multiple computers.

The acronym “XML” generally refers to the Extensible Markup Language. It is a general-purpose specification for creating custom markup languages. It is classified as an extensible language because it allows its users to define their own elements. Its primary purpose is to help information systems share structured data, particularly via the Internet, and it is used both to encode documents and to serialize data.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively the entire processing system may be self-contained on a single device.

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touchscreens, displays, pocket pagers and terminals as well as remote connected computer systems, modems, radio transmitters and handheld personal communication devices such as cellular phones, “smart phones” and digital assistants.

The processing system may also include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventor contemplates that the methods disclosed herein will operate over a network such as the Internet, and may be effectuated using combinations of several processing devices, memories and I/O.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS, telephony and other I/O functionality.

### Client Server Processing

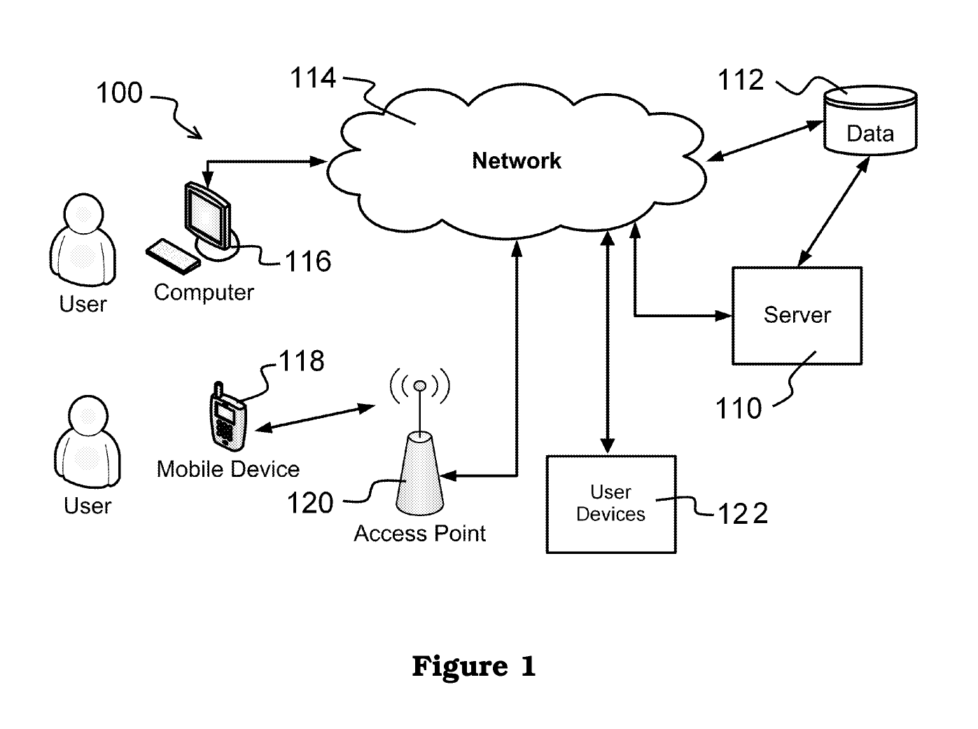

FIG. 1 shows a functional block diagram of a client server system 100 that may be employed for some embodiments according to the current disclosure. In the FIG. 1 a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively the user may access the server 110 through the network 114 by using a smart device such as a telephone or PDA 118. The smart device 118 may connect to the server 110 through an access point 120 coupled to the network 114. The access point may operate using standard WiFi techniques. The mobile device 118 may include a sound capture device such as a microphone as well as a speaker.

One having skill in the art will appreciate that services such as cloud service providers may be coupled to the network 114 and provide services such as data storage 112 and servers 110 among others. Moreover, a database 112 may be effectuated using conventional tools such as MySQL, SQL Server and the like.

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java and JavaScript.

Smart phones often distribute processing among several devices allowing, at times, for the phone to be the server or for interactions between the smart phone and web servers and browsers.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, an execution engine, a user interface (UI) engine and the like may be employed. These engines may seek and gather information about events from remote data sources. Moreover, engines may be configured to effectuate various combinations of the techniques described herein.

In addition to digital communications to a network 114, mobile devices 118 such as cell phones may include 3G, 4G or others forms of voice telephony. These include, without limitation, Mobile WiMAx and Long Term Evolution (LTE), and other voice over IP (VoIP) standards.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Calls

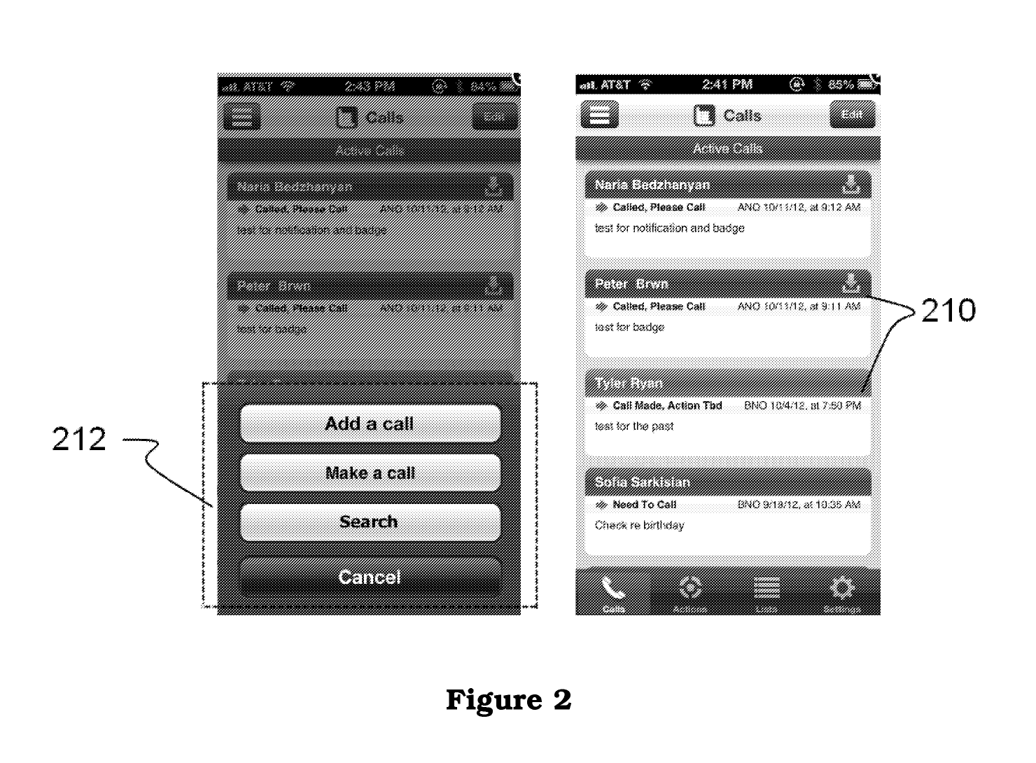

FIG. 2 illustrates an embodiment of call processing system components according to certain aspects of the current disclosure. FIG. 2 shows controls for management of messages, which may be effectuated on a mobile communications device such as a smartphone. The communications device may be operable for voice telephony across a common carrier wireless network. A call processing system may include an interactive call log or phone sheet for tracking call activity (or actions) from start to finish. As used herein a call may be a collection of call activities including, but not limited to:
an initial attempt to communicate
leaving a message or voice mail
attempts to return communications in response to a message
completed communications
notes and follow up activities
   While the inventors contemplate a call being primarily based around voice communications, this application should not be limited to only voice communications because multiple communications methodologies my be employed using the techniques and systems described herein. For example and without limitation text and email may also be employed or a combination of voice, text and email may be employed in certain embodiments.

Each call action is memorialized in a structured data store which, in turn, provides a history of the interactions associated with every call. Call actions can be added manually or, in certain embodiments, automatically in response to certain user interactions such as selecting a person from a mobile devices address book after syncing it with the structured data store.

A rules lookup table (or message action table) may also be employed wherein the call actions may also be associated with rules directing an operating system to perform certain activities in response to a call action. This allows for different users to have different operations in response to different call actions. For example and without limitation, one user may want calls returned using the common carrier telephony built into their smartphone, while another always returns calls using a VoIP service such as Skype. A rules lookup table may also provide for integration of a mobile application into an email application, text messaging or the native telephone call log provided by the operating system of the smartphone by directing certain call actions to interact with those services. Some embodiments may employ different rules tables for different devices. For example and without limitation a single manager (“boss”) may have different rules for his or her iPhone, iPad and web interface and the associated assistants may have a different rules table as well.

In some embodiments co-workers may share rules and call actions. In an exemplary instance, if a call were to come in for a specific person, the person may transfer the call, along with its incumbent responsibilities to another person. In those situations the call activity may show transferred and the call history record may be transferred to the new responsible person. These situations may arise when more than one person is involved in dealing with customers. For example and without limitation a customer may call a tech service line where the call is prioritized and logged to a specialist. The specialist may then transfer the call to a filed engineer for completing the call activity.

Once a call has been started, each call action 210 can be tracked and logged to the call along with a note of explanation. The positions of the controls and indicators of FIG. 2 are graphically designed to show the state (i.e. new, in progress, completed, need to call) and status (i.e. call received, left voicemail, etc) of each call. Certain embodiments may include along with additional icons indicating urgent calls, returned calls and the like. Some embodiments may employ color to indicate information about a call. For example and without limitation, the color red may indicate a new call and the color blue may indicate the call is in progress.

User controls 212 allow for adding, making and searching for call information. The response to a user input may depend on the type of device in operation. For example and without limitation, if the embodiment is operating on an iPhone, when the user selects “Make a call”, a display of contacts may be displayed for selection by the user. The display of contacts may be from the iPhone's native contact database, from a 3^{rd} party supplied database, or from a network-connected database. Upon selecting a contact a telephone call may be initiated. If the device is a tablet, or other device without common carrier connectivity, then a VoIP call may be initiated over a WiFi network.

When the user selects “Add a call” or “Make a call” a new transaction history is created. The process may include a first step which includes the user selecting whether to get the contact from the address book or manually enter it. The user then enters in the call information (i.e. action type, note, headline, mark as urgent, call date among other).

Recording of call actions in a structured data source may be effectuated through calls to a local data store such as Apple's Core Data database provided on an iPhone or other local memory. API calls to a web server may be employed for making message information available to other devices by storing data that on a server for later synchronization. For example and without limitation, web-based embodiments may use cloud-based data stores such as Apple's iCloud data service or Amazon's AWS service.

In certain embodiments call actions may include activities and information not directly related to servicing a particular communication. For example and without limitation, a call action may be “add to docket”, “scheduled meeting”, or “send documents” or other activities related to operating a law firm. Similarly businesses may include “sent literature”, “expecting a call”, or “follow up in two weeks.”

### Users

The message management system may operate with a single user to manage calls or with a “boss and assistant” model. The boss and assistant model may be expanded to include multiple bosses with multiple assistants. Once the boss information is stored in the structured data store, the boss may enter a web or mobile application to add or manage assistants. In the boss and assistant model, a boss is the person the call activity is directed towards while an assistant is a person who intervenes at times when the boss is not involved in the call activity. For example and without limitation a third party may attempt to communicate with a boss. An assistant such as a secretary or receptionist receives the call. The assistant may use a Web interface or smartphone App to add/manage the call action. As the assistant enters the call action, the action information may be pushed out to all the boss' devices as well as any other assistants. If the call is critical, the assistant can mark the call to notify the boss and the boss will get a text-like or instant-message like notification alerting them of the call activity.

In some embodiments there may be several types of assistants. For example and without limitation:
An assistant who can manage the boss' profile including but not limited to add a call actions, assistant actions, boss actions
An assistant who can manage user accounts
a temporary assistant who account expires on a specified date
   Recording of boss/assistant relationships and permissions may be effectuated through lookup tables in a structured data store.

### Contact Integration

In some embodiments the boss or other authorized user may sync an address book to a system-wide account. All the entries from an address book on a mobile device are then encrypted and sent to the server. When the assistant goes to add a new call, the Web interface will show the matching contacts for them to use. If they add a new person that is not in the address book, they'll get a VCard by email to add the new contact information to the boss' more permanent address book or to sync with the address book on the boss' phone. Contact synchronization may be effectuated using the tools and techniques described herein in other sections.

### Alarms

In certain embodiments alarm functions are effectuated to provide for differing call priorities. For example and without limitation when calls are past due, the system may alert a user. For calls that are time-specific, a user may set a profile variable to provide for notification parameters. For example and without limitation, a user may set an alarm for an hour before the call is scheduled and then again five minutes before the call is to occur.

### Security

In certain embodiments all traffic between servers, web clients, and apps is encrypted. Moreover, data stored on servers may be encrypted as well.

### Sync Across Devices

Some embodiments may operate using the Internet or cloud computing. This allows for securely sending information to each authorized mobile devices in the network. Multiple computing devices such as an iPhone, iPad, and Android devices may all be synchronized to a common structured data store. In some embodiments the mobile devices may be stored in a predetermine list linking a manager to a group of mobile devices or multiple managers together. Each device will include localized data to the device and synchronization may be effectuated using transactions exchanged between the devices. In situations where the device is not connected to a network, call actions may still be recognized by storing the call activity in a localized queue for later processing when the device is coupled to a network or server.

Syncing may be effectuated using a centralized call log. Rather than attempt to synchronize multiple databases and reconcile their various states, some embodiments may send and receive immutable transaction records to and from a mobile app. The state of a call is the sum of its transactions. These transactions may be represented by a user actions table in the structured data store. These immutable transaction records are not changed once they are created because they represent an event at a moment in time, not the current state of a call.

In certain embodiments the same user action record may be sent by a mobile app multiple times without ill effects because once a user action is recorded, subsequent copies are ignored, thus effecting idempotency. For example and without limitation, if the mobile app sends a user call action record, but loses connectivity prior to receiving a successful response, the app will attempt to send the action again during the next synchronization.

To avoid polling for call changes push systems such as the Apple Push Notification system, or Google's cloud messaging (“GCM”) may be used to inform the mobile app of any changes. In some embodiments, unless the user has selected the Notify Boss option, when creating a call action, these notifications are silent and simply trigger a synchronization event in the background processing of the mobile application. These notifications are useful for timely receipt of changes. A user can create an event on via the Web interface and have it shared on multiple devices within a few seconds.

The call processing system as described herein may be effectuated using one or more of the following components for the mobile application or the server.

### On the Mobile Application

User Action Queue. When a user adds a call or creates an action for an existing call, the action is placed into a queue pending synchronization. If the user has connectivity, the queue may be processed immediately and the actions sent via a “send user actions” API call. Otherwise, the queue remains until connectivity is restored. The queue not cleared until a success response is received from the server.

Core Data Database. On the device, there may be a lightweight core database or other native data store. It stores the current state of the call as a UserMessage object and events as UserActions objects. There are also a number of support objects for users and settings. These latter objects may be loaded from the server upon login or when settings are changed.

Notification Listener. When the mobile app is running, the app may listen for notifications from the server via a Push Notification Service. These notifications might have visual component, alerting the user to a new call or update to an existing one, or they can be silent with the app processing them in the background. This processing may allow for near real-time updates to calls while the user is actively using the app.

### On the Server

Application API. The API layer handles communication between the mobile app and a web service. It may provide for authentication and synchronization. There may be 2 primary calls with respect to synchronization, send user actions and fetch user actions. The first call is used to send user actions from the device to the server. The second is used to pull user actions from the server. During synchronization, the app may flush the queue of pending actions from the device and then receives the latest actions from the server. When requesting user actions, it uses the server-provided timestamp of the most recent action received in order to only fetch new actions.

Server Database. The server may maintain a database into which the user actions are stored. These may be timestamped via the created_on field when they are inserted into the database, regardless of how long in the past the actual call or update may have taken place. Accordingly if the event is “new” from the server perspective, it will be delivered to the secondary device upon the next sync.

Notification Service. The notification service on the server sends event notifications whenever new user actions are created. These actions can be created via the API or web application. A web application may invokes the send notification API call for registered devices.

### Operations

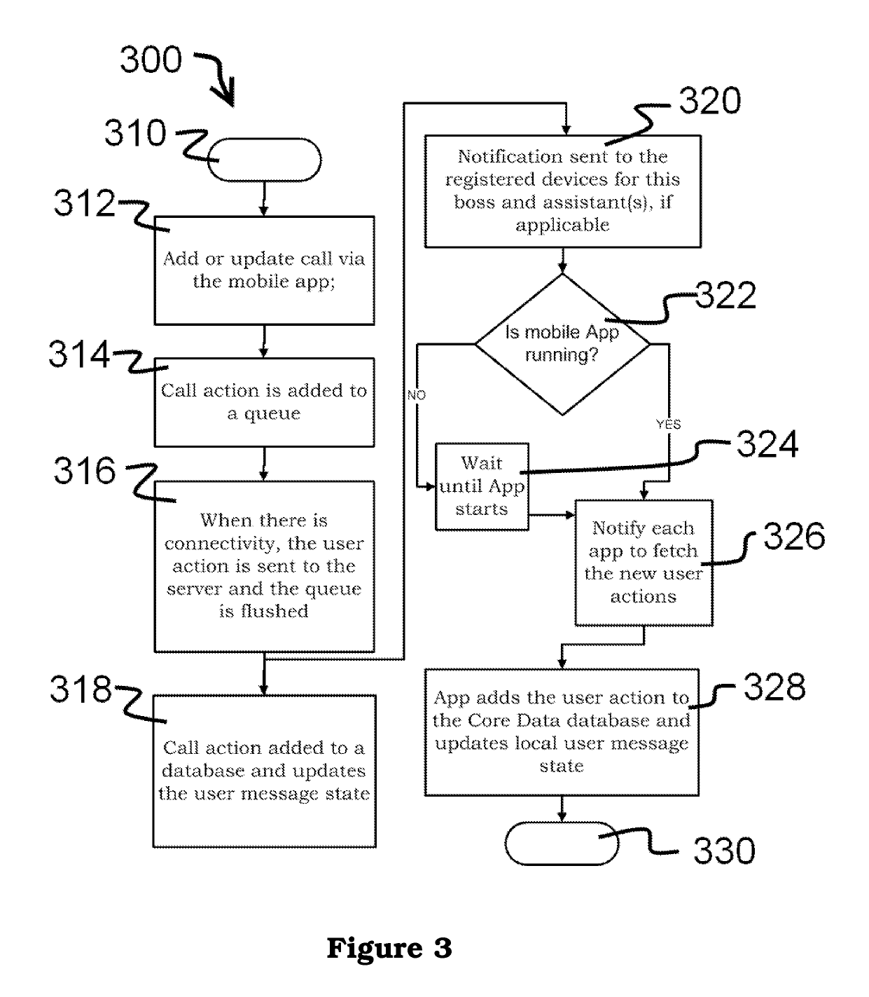

FIG. 3 is a flowchart 300 illustrating certain aspects of the current disclosure. The method begins at a flow label 310. At a step 312 a user adds or updates a call via the mobile app. This could in response to receiving or making a call.

At a step 314 the user action is added to a queue stored locally on a device.

At a step 316 there is a test for connectivity to a server. When there is connectivity, the call action is sent to a server. This transmission may be effectuated through an API. Once the transmission is sent, queue is emptied. In some embodiments, emptying the queue may occur after the server acknowledges successful processing.

At a step 318 the call action is received at the server and added to a database and the call state is updated. Synchronization as described herein may be effectuated at the appropriate steps.

At a step 320 notifications are sent to each device registered for this boss and associated assistants.

At a step 322 operation changes depending on whether a mobile app is running on a device. If an app is running, operation moves to a step 326, if not operation moves to a step 324.

At a step 324 the app does not fetch the call actions, but instead will fetch them the next time the mobile app is launched.

At a step 326 the app on each device receives the notification and fetches the new user actions.

At a step 328 the mobile app adds the user action to the Core Data database on the device and updates the local user message state.

The method ends at a flow label 330.

Similar to the operations on a mobile device, the Call added or updated operation on an Internet browser may be effected through the following process:
The user adds or updates a call via the Web interface;
The user action is created and stored in the database;
The state of the corresponding user message is updated;
A notification is sent to all registered devices for this boss and assistant(s), if applicable;
If active, the app on each device receives the notification and fetches the new user actions;
If not active, the app fetches the new user actions the next time it is launched;
The app adds the user action to the Core Data database and updates the local user message state.

Certain embodiments may also include a call request control wherein a user may request a call from another user. In this embodiment, the call request is transmitted to the second user and it shows as a call in the second user's call actions.

Smartphones may include native software to manage calling and call logging. In certain embodiments a call processing system may operate using two independent call logging systems thus allowing a user to make a telephone call by selecting call back from either of the call histories, the native one or one embodied in a call processing system. Some embodiments may include synchronization between a native call (or message log) and a message log according to the current disclosure. One having skill in the art will appreciate that some embodiments may replace native message and call logging with routines and methods presented herein.

For mobile applications, the mobile app synchronizes with the server whenever it is launched, brought to the foreground or connectivity is restored after being offline. When a new call is added via the mobile app, there may be no corresponding user message object on the device. Thus a temporary user message object may be created with an ID outside of the server's usual ID range (for example, a negative number may be used). Once the user action is received and processed by the server, a user message object is created and a permanent ID allocated for that call. When the user action is subsequently fetched by the server, the temporary ID may be replaced with the permanent ID in the mobile device's local data store or Core Data.

If a mobile app's local database becomes corrupted or inaccurate, the user may either log out and log in again or press Refresh Call Data on the Settings screen to re-sync the data. This removes the call data from local data store and re-fetches the user actions from the server, rebuilding the local user message state in the process.

Some embodiments may use lookup tables such as the user profile, settings and available rules (message actions). These are fetched upon login, when changing the settings, or dynamically when needed. For example and without limitation, if a new user action references a message action that does not exist on the app, it will attempt to fetch that message action from the server.

The above illustration provides many different embodiments or embodiments for implementing different features of the invention. Specific embodiments of components and processes are described to help clarify the invention. These are, of course, merely embodiments and are not intended to limit the invention from that described in the claims. Moreover the attached appendix, which is incorporated herein by reference, includes alternative embodiments.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method including:
receiving from a first remote device, information, said information including a call action;
testing that call action for prior reception of the same information;
storing the information in a structured data store in response to said testing;
transmitting a push notification to a second remote device;
waiting for a response from the second remote device, and
transmitting the call action to the second remote device based on the response.

2. The method of claim 1 wherein the second remote device is selected from a predetermined collection of remote devices.

3. The method of claim 1 wherein the call action is selected from a queue stored on the first remote device.

4. The method of claim 1 wherein the call action includes an information representing at least one of a call received, a message received, or a request to call.

5. The method of claim 1 wherein the first remote device and the second remote device are wireless devices.

6. The method of claim 1 further including:
testing the call action against a rules lookup table, and
altering the call action in response to the testing.

7. The method of claim 1 wherein the call action includes information representing at least one of a customer request, a sales call, or a technical request.

8. One or more processor readable storage devices having processor readable, non-transitory, code embodied on said processor readable storage devices, said processor readable code for programming one or more processors to perform a method including:
receiving from a first remote device, information, said information including a call action;
testing that call action for prior reception of the same information;
storing the information in a structured data store in response to said testing;
transmitting a push notification to a second remote device;
waiting for a response from the second remote device, and
transmitting the call action to the second remote device based on the response.

9. The device of claim 8 wherein the second remote device is selected from a predetermined collection of remote devices.

10. The device of claim 8 wherein the call action is selected from a queue stored on the first remote device.

11. The device of claim 8 wherein the call action includes an indicia representing at least one of a call received, a message received, or a request to call.

12. The device of claim 8 wherein the first remote device and the second remote device are wireless devices.

13. The device of claim 8 wherein the method further includes:
testing the call action against a rules lookup table, and
altering the call action in response to the testing.

14. The device of claim 8 wherein the call action includes information representing at least one of a customer request, a sales call, or a technical request.
